(19) United States
(12) Patent Application Publication
(10) Pub. No.: US 2014/0215323 A1
(43) Pub. Date: Jul. 31, 2014

(54) ELEMENT DETECTION AND INLINE MODIFICATION

(71) Applicant: APOLLO GROUP, INC., PHOENIX, AZ (US)

(72) Inventors: Lance Nelson, Clyde Hill, WA (US); Alan Allison, Seattle, WA (US)

(73) Assignee: APOLLO GROUP, INC., PHOENIX, AZ (US)

(21) Appl. No.: 13/751,076

(22) Filed: Jan. 26, 2013

(51) Int. Cl. G06F 17/24

(52) U.S. Cl. CPC G06F 17/24
USPC 715/256

(57) ABSTRACT

A test management system and method is disclosed. A document is analyzed and parsed to identify the various elements that make up the document. Alternative values are received for one or more of these elements. In response to receiving a request for the document, the test management system generates a variation of the document based on alternative values. Multiple versions of the document are generated based on the alternative values as additional requests for the document are received.

### FIELD OF THE INVENTION

The present invention relates generally to multivariate testing systems. In particular, the present invention relates to efficient modification of documents for testing purposes.

### BACKGROUND

Web-based advertisers often send advertising traffic to landing pages that are designed to convert web traffic into action by the viewer of the landing page. For example, a person may search for a widget manufacturer using a search engine, and then click on (select) an advertisement for ABC widget manufacturing company. This selection takes the user to a landing page that is designed to allow the user to easily request the information he desires about the products he is interested in.

Advertisers often compare several versions of a landing page with one another to determine which version of the landing page is performing the best. Performance may be based on various metrics, such as click-through rates. In the example above, performance may be based on the percentage of viewers that have filled out an information request form on the landing page.

A popular way to perform such testing is known as A/B testing. In A/B testing, each of the landing pages is identical, except for one variation that the advertiser suspects may affect performance. As performance data is gathered, a winner emerges, and the winning version is tested against another version. The process is repeated indefinitely. One problem with A/B testing is that it only allows for one variation.

Multivariate testing allows for more than one variation of a website to be tested at the same time. It is similar to performing multiple A/B tests at the same time. However, more variables result in a more difficult test set-up, as one web page needs to be created for each of the versions to be tested. This process can be time consuming.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a logical block diagram of a computing device on which an embodiment may be implemented;

FIG. 1A illustrates a logical block diagram of a computing device on which an embodiment may be implemented;

FIG. 2 illustrates a method for generating multivariate testing data according to an embodiment;

FIG. 3 illustrates a user interface for selecting testing criteria in an embodiment;

FIG. 4 illustrates a user interface for selecting testing criteria in an embodiment;

FIG. 5 illustrates a user interface for selecting testing criteria in an embodiment;

FIG. 6 illustrates a user interface for selecting testing criteria in an embodiment;

FIG. 7 is a flow diagram that represents a method for implementing an embodiment;

FIG. 8 illustrates a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In an embodiment, a test management system enables users to select different elements of a document for testing in a multivariate testing environment. Documents that may be tested may include any document that has structure that defines the elements that make up the document. For example, documents that are capable of being parsed using DOM such as those that use a markup language (e.g., HTML or XML) may be used to generate multivariate testing data.

A user of the test management system selects a document on which to base the test. In response to the user selection, the test management system parses the document into the various elements that make up the document. For example, the document may be broken down into the various text paragraphs, images, colors, videos, fonts, and other elements. For HTML documents, CSS (Cascading Style Sheet) elements may also be parsed.

Parsing techniques may differ, depending on the type of document being parsed. Parsing HTML and XML documents can be performed by reading the various tags associated with the elements of the document. For example, the <par> and </par> tags indicate the beginning and the end of a particular paragraph in the document.

After some or all of the elements of the document are discovered, the document is presented to the user in “edit” mode. This mode allows the user to select the elements that should be tested by the test management system. In an embodiment, edit mode allows the user to select an element by clicking directly on that element in the document. By clicking on a paragraph containing text, for example, the user may be able to define several different versions of the text to be tested against one another. As another example, by selecting the background, the user may be able to define several, or even a range of background colors to test. In an embodiment, themes may be tested against one another.

In an embodiment, instead of generating a single web page for each possible combination of elements, the test management system keeps track of the element options in a database or other storage. As requests come in for “the page,” various versions of the page are dynamically delivered to the requestors, the various versions being created on-the-fly using the stored options selected by the user. The test management system then collects information about the performance of the various options.

### Structural and Functional Overview

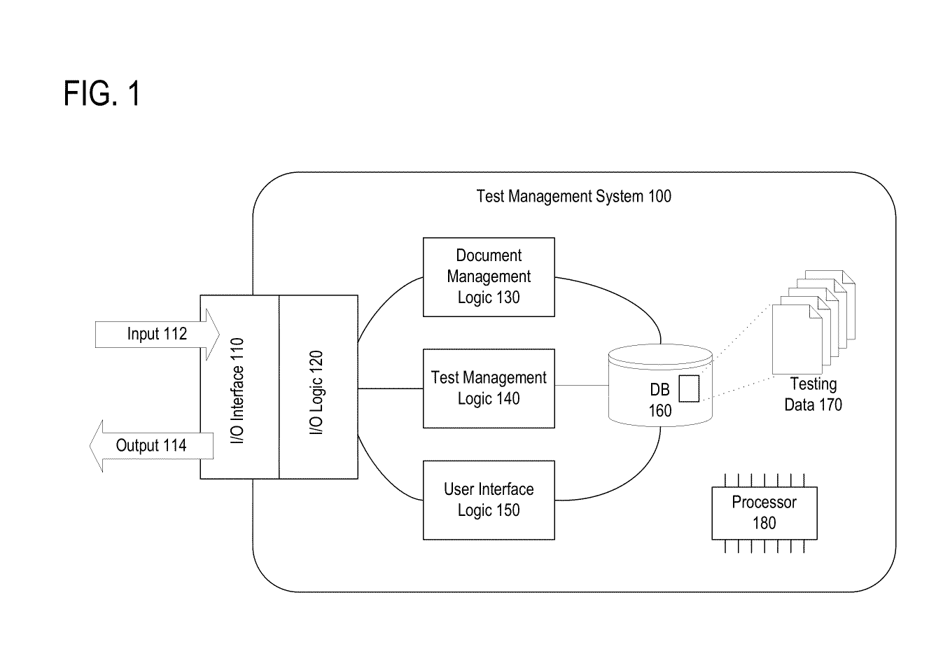

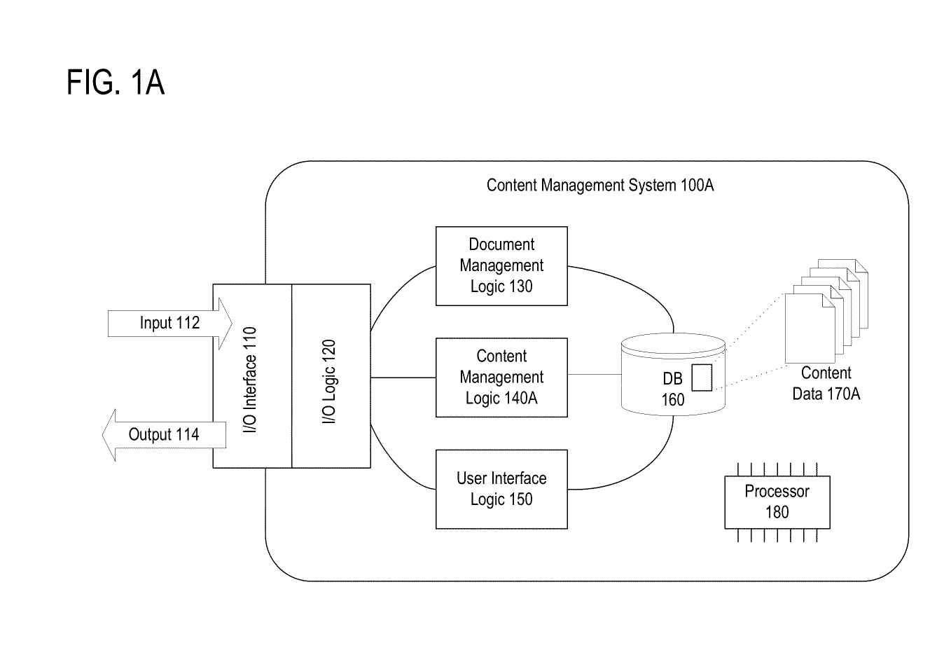

FIG. 1 is a simplified block diagram illustrating a test management system 100 on which an embodiment may be implemented. In the embodiment shown in FIG. 1, test management system 100 is a collection of modules 110, 120, 130, 140, and 150, each of which may be implemented in logic such as software logic, hardware logic, or any combination thereof. Test management system 100 includes an input/output (I/O) interface 110 in an embodiment. In another embodiment, I/O interface 110 is not part of test management system 100, but is coupled to test management system 100. I/O interface 110 may be configured to couple test management system 100 to a user input device such as a keyboard 104, mouse 102, trackball, touchpad, touch screen, joystick or any other user input device or pointing device. I/O interface 110 may also be configured to couple test management system 100 to other devices or means of providing or interpreting signals or data such as an input 110, including a network, display device, or transmission media device capable of transmitting or displaying an output 114. In an embodiment, I/O interface 110 may represent multiple I/O interfaces.

Input 112 may include input from a pointing device and input from a keyboard such as keyboard 104. For example, input 112 may include a signal defining the movement of a scroll wheel on a mouse such as mouse 102 and/or signals from a keyboard that define which button(s) are being or have been pressed. In an embodiment, input may represent input data received from a client interface, which may be implemented as a native application, browser plug-in, web page code, or other user interface supporting software that may be distributed to a client computer. Input 112 represents a change to a web page or document element in an embodiment. Output 114 may include display data, which may include a user interface element that can be displayed by a display device. Output 114 may also include feedback to user input devices, other application data, or information sent to another system via API (Application Programming Interface).

Test management system 100 includes an I/O logic 120 configured to receive input 112 from I/O interface 110. I/O logic 120 may be configured to store input 112 or information associated with input 112 in non-transitory media, such as volatile or non-volatile storage media. For example, I/O logic 120 may include logging logic.

I/O logic 120 is communicatively coupled to I/O interface 110, user interface logic 150, a test management logic 140, and a document management logic 130 in the embodiment shown in FIG. 1. In other embodiments, additional elements of computer system 100 may be coupled to I/O logic 120. In addition, elements not shown in FIG. 1 may be added in other embodiments, and the configuration of elements of the computing system may differ from the configuration shown in FIG. 1. For example, I/O logic 120 may be incorporated into document management logic 130 or user interface logic 150, and a database or other storage means may be remotely connected to test management system 100. Test management system 100 is coupled to a processor 180 in an embodiment, which may comprise hardware logic in the form of one or more central processing units (CPUs) each having one or more cores.

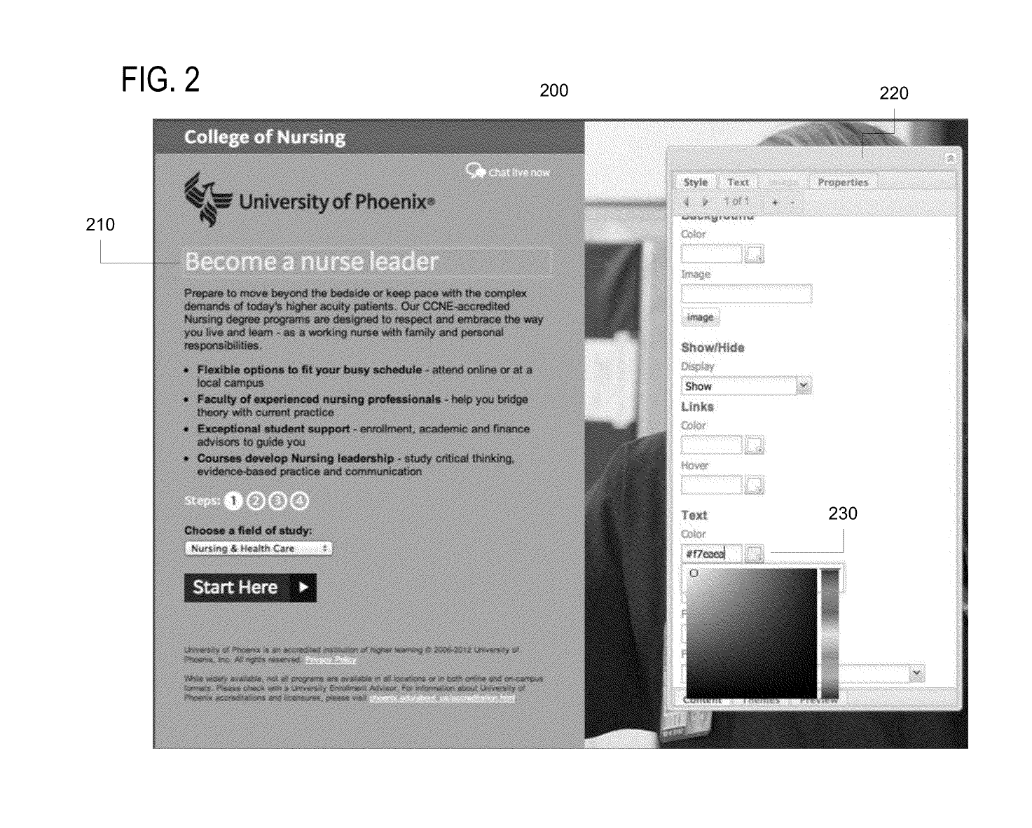

In the embodiment of FIG. 1, user interface logic 150 is communicatively coupled to I/O logic 120 for receiving user input, document management logic 130, test management logic 140, and User interface logic 150. These modules are also coupled to a processor 180 in an embodiment. In an embodiment, user interface logic 150 receives user input from I/O logic 120 and processes the input to determine whether user interface should be generated. In an embodiment, user interface logic 150 generates a user interface for display based on the input 112, and presents the generated display to I/O logic 120. The generated display is sent as output 114 to a network, display device, or other means of sending or presenting the display. In an embodiment, user interface logic 150 may also be communicatively coupled to other elements of test management system 100 that are not shown. For example, in an embodiment, presentation logic is combined with user interface logic 150, which is configured to generate the user interface and user interface elements that may be displayed to a user. For example, referring to FIG. 2, user interface logic 150 may generate one or more elements of user interface 200 in an embodiment. In an embodiment, a user interface is made up of user interface elements. Some user interface elements may be interactive, while others may not be interactive. User interface elements may be generated based on data in a database such as database 160, graphics in a graphics repository, or other information that may be retrieved or dynamically generated by test management system 100. In an embodiment, presentation logic generates output 114 that includes the user interface and/or user interface elements.

Test management logic 140 is communicatively coupled to I/O logic 120, user interface logic 150, and document management logic. Test management logic 140 generates and executes A/B and multivariate testing scenarios based on user input testing data 170 in an embodiment. Testing data 170 is generated by document management logic 150. Testing data may represent various web pages or other documents to be tested against one another in an embodiment. In another embodiment, test data 170 represents the various changes that are made to various web page that is being tested. For example, if the web page being tested originally has a blue background color, and the user desires that the page with the blue background be tested against the same page with a red background and a yellow background, then the “deltas” or changes to the web page are stored in database 160 as testing data 170. Testing data 170 may be stored with identifiers that map the deltas to the original web page objects that the deltas are meant to change. In an embodiment, test data 170 also includes database entries or other storage of individually identified elements of a document that is to be used for testing. These elements, which are identified and stored by document management logic 130 when document management logic receives the original document as input 112, are swapped out with delta test data 170 by test management logic 140 during testing. In an embodiment, new documents may be generated based on the original document elements and the delta testing data 170 before testing begins.

User interface logic 150 generates user interface elements in response to input associated with certain operations, such as zoom operations. For example, a user may request a zoom-in operation or a zoom-out operation by providing input signals or a combination of input 112 signals to I/O interface 110 via one or more user input devices. In response to the input signals or data, included in input 112, user interface logic 150 may generate a menu, tooltip, or other user interface element(s) to be displayed to a user in response to the selection, by the user, of an element or group of elements to. These user interface elements may be used to select the changes (deltas) in the document to be tested. User interface logic 150 may provide the user interface elements directly to a presentation logic, or may first combine the user interface elements with other user interface elements. All or a portion of a user interface may then be sent as output 114. Output 114 may include instructions to a browser or other software capable of interpreting output 114, or may be readable by a monitor that directly receives output 114. In an embodiment, a presentation logic generates instructions for generating the user interface or user interface elemtnes to be displayed to the user and sends the instructions within output 114. Output 114 may also include other elements of a display such as user interface 200. The user interface may be updated by user interface logic 150, and the updated user interface may be displayed in an embodiment. For example, if a user selects a new element to be tested by providing input or a combination of input 112, then user interface logic 150 may update the user interface or generate a new user interface to be displayed, and the updated user interface or new user interface may be displayed by presentation logic.

### Example Implimentations

In an embodiment, a user selects a web page or other document on which to base a test. In other words, a user may want to test multiple versions of the web page against each other to see which elements of the web page may be changed to increase performance of the web page. Such testing, for example, can reveal whether using dark blue for a text color will cause more visitors to the web page to fill out a form on the web page than if the text were black, red, or orange. The web page may be any web page accessible to the user by a browser, and may be selected by means of a bowser plugin. In an embodiment, the URL of a web page is passed to test management system 100. In another embodiment, the web page and associated documents are passed to test management system 100 as input 112. The web page and associated documents may also be uploaded to test management system 100 manually, and stored in database 160. The imported web page acts as a template for performing a multivariate test.

The selected web page is parsed by document management logic 130 in an embodiment. Document management logic 130 identifies each element of the web page by reading the tags within the web page, as well as the CSS elements and their properties. Document management logic recognizes any element of a web page that conforms to the Document Object Model. The Document Object Model (DOM) is an application programming interface for valid HTML and well-formed XML documents, and it defines the logical structure of documents and the way those documents are accessed and manipulated. DOM also allows for the parsing and manipulation of CSS properties.

For example, a web page may have <p> and </p> tags, with text between them, indicating a paragraph of text. Document management logic 130 recognizes this as a DOM element that represents a paragraph. Additional elements such as headings, text, background colors, text colors, layout, images, and multimedia objects are also identified by document management logic 130. Reference to these objects is made in Database 160. For example, a document identifier may be used to represent the document, and elements may be identified as elements of that document by making reference to the document identifier. The document may also be associated with other metadata. Elements may also be associated with an identifier, and may have additional metadata associated with them such as the values associated with the elements, element order, and whether or not the element is the original element associated with the document.

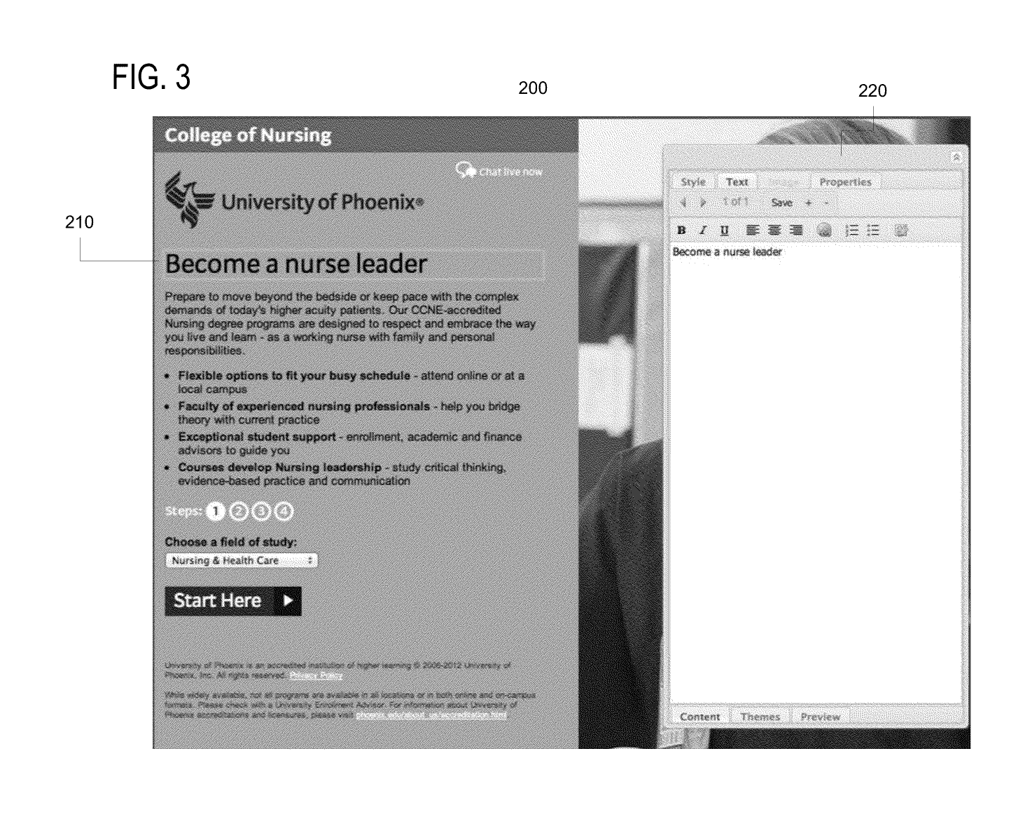

User interface logic 150 generates a user interface such as user interface 200 in an embodiment. The user interface may display the selected web page, along with a tool interface 220 to select elements of the web page to be tested. Elements that may be tested may be identified in the user interface 200. For example, a box may be placed around objects that may be tested. In an embodiment, this box only appears when the user's mouse hovers over the element. In FIG. 2, element 210 represents a DOM element that is associated with text. Tool 230, in this example, is being used to select a text color to be tested with this web page. Making reference to FIG. 3, tool interface 220 may also be used to select text to be tested in association with element 210. In an embodiment, any number of variations on the text content or color may be selected for testing.

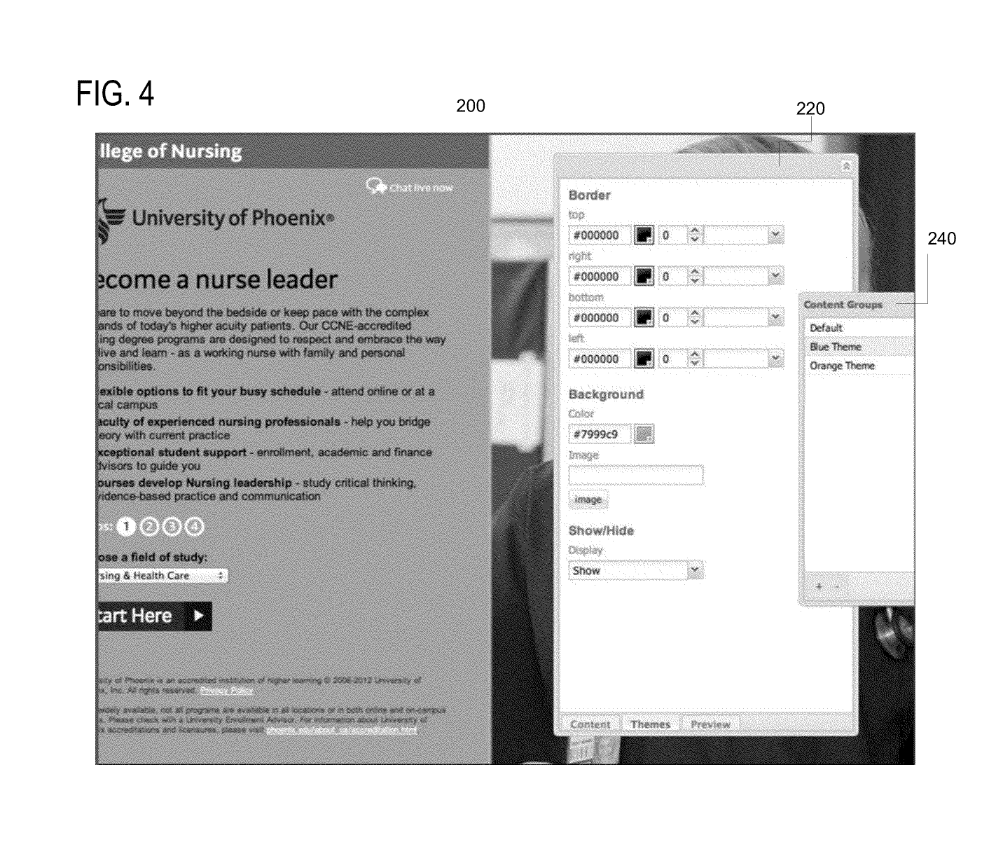

In an embodiment, themes may be tested against one another. Themes allow a set of elements to be grouped together as one variation to be tested. For example, it is not desirable to test certain colors that are non-functional or are known to be aesthetically unpleasing. Themes help avoid testing pages that have a black background with black text, or a white background with white text, for example. By choosing theme colors that are known to be aesthetically pleasing, color schemes can be tested against one another quickly, and without losing statistical relevance by avoiding unwanted color schemes. FIG. 4 represents an example user interface that includes a theme tool 240 to allow selection of themes to be tested. In an embodiment, themes are implemented in this way by storing changes associated with a Cascading Style Sheet.

In an embodiment, images, sound files, and other multimedia objects may be selected for testing. For example, the user interface may allow for the selection of a picture as an element to be tested. Tool interface 220 may provide for the upload of the alternate images, for example. These images are then stored in database 160 or another storage medium and associated with the document element to be tested.

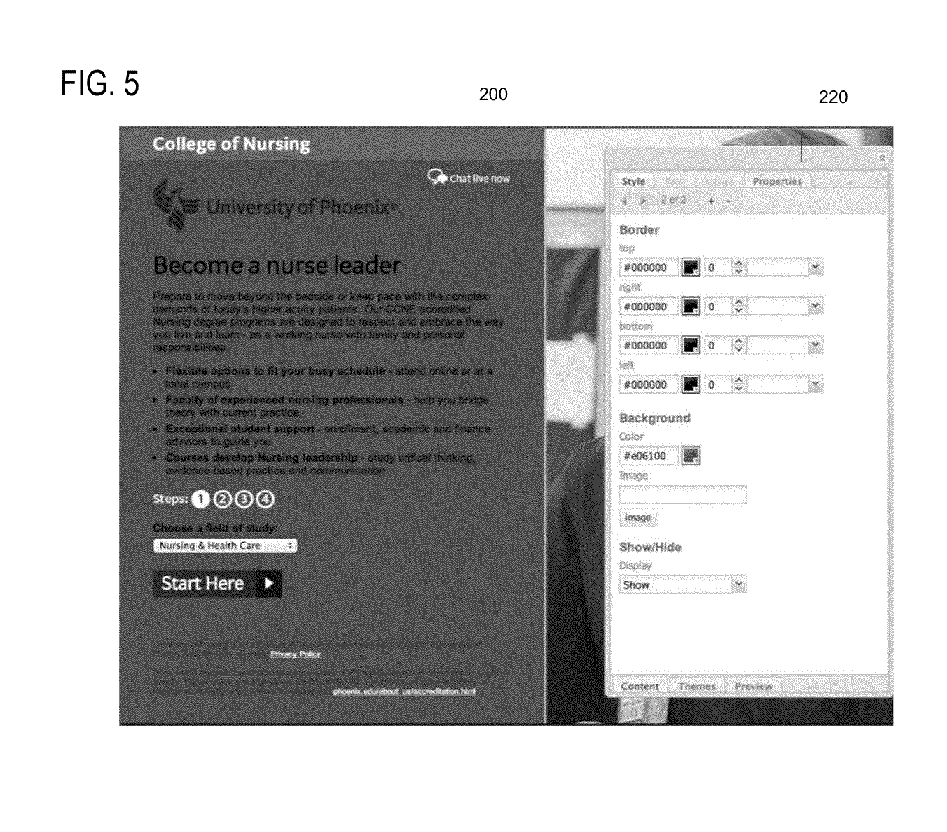

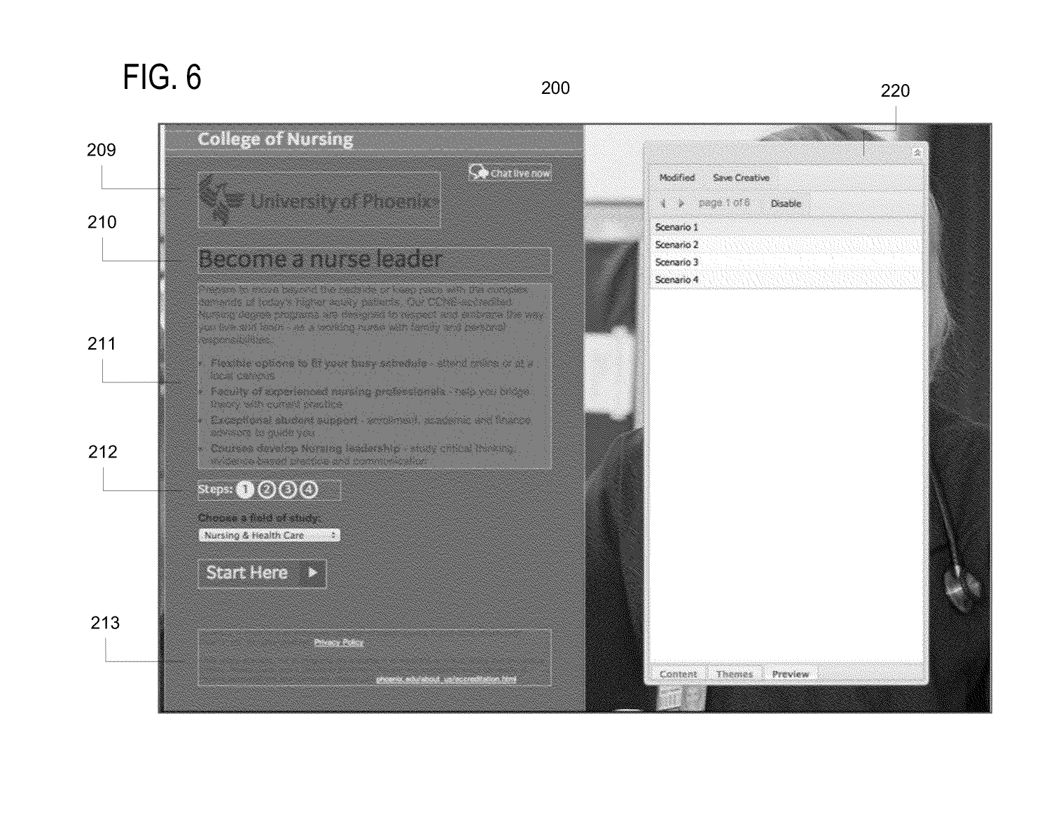

FIG. 5 represents an example user interface in an embodiment. The user may be able to select various colors to change in a web page or test using tool interface 220. FIG. 6 represents an example user interface in an embodiment. The user may be able to select various themes to change in a web page or test using tool interface 220. In addition, elements 209-213 are elements of the web page that may be changed or selected for testing in an embodiment. For example, element 209 may be selected in order to allow the user the change the image that is shown in that portion of the web page. Element 211 may be selected in order to allow a user to change the text associated with element 211, and so on. In an embodiment, any portion of a web page or any other document may be changed if it can be recognized by document management logic 130.

As various elements are selected for testing, test management logic 140 stores the information about those elements and the desired variations associated with those elements as testing data 170. Once testing begins, test management logic 140 manages the generation and display of the web page that is to be tested. A request for the web page is received at test management system 100. In response to the request, test management logic determines a combination of elements associated with the web page to be tested. A particular version of the web page (including required documents and files) is generated based on testing data 170 and delivered to the requestor based on this determination. For example, the web page that is delivered to the requestor may include text that is different than the text in the original version of the web page. As each request for the web page is received, a version of the web page is generated by test management logic 140 and delivered to the requestor. Test management logic 140 tracks the performance of each web page in an embodiment.

Test management logic 140 can be configured to allocate a portion of requests to the testing of certain elements in an embodiment. For example, it may be more desirable to test the text changes than it is to test the color changes. In an embodiment, test management logic can prune test elements as statistically relevant determinations are made. In other words, test elements that are determined to be unhelpful to performance of the page are automatically removed from the test. Test management logic 140 may also be configured to test certain types of traffic with certain changes to the web page. For example, if the request comes from the Pacific Northwest, an “earth tone” theme may be tested, even if that theme is not tested with other traffic.

### Method for Generating Testing Data

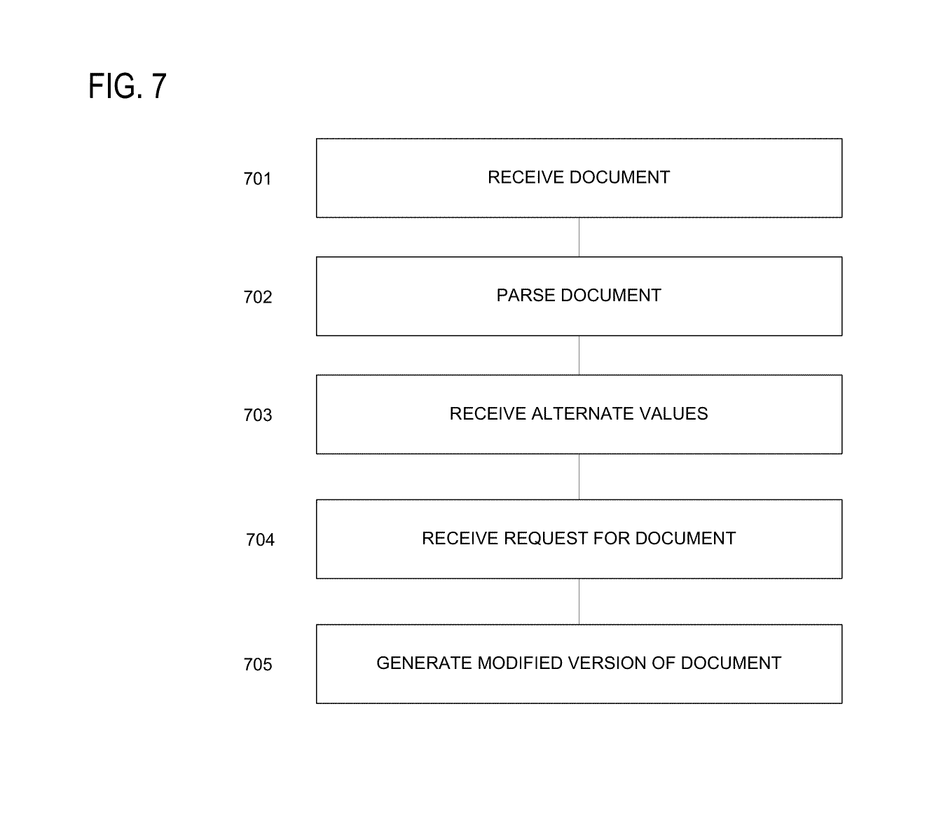

FIG. 7 is a flow diagram that represents a method for implementing an embodiment. At step 701, a document is received by test management system 100. The document may include various document elements, such as text, images, formatting information, color codes, and multimedia items, or even references to other documents. The document is parsed to identify elements of the document.

At step 702, the document is parsed to detect the elements that comprise the document. In an embodiment, elements of the document are associated with values. For example, a paragraph element may be associated with text, or an image element may be associated with a particular image file.

At step 703, a request that is associated with a particular element is be received, along with a value that is different from the original value of that element. For example, a user may select a text heading element and make changes to the element, sending the change to test management system 100. The changed value is stored without overwriting the original value. This enables the changed value to be tested against the original value. Other alternate values for the various page elements may also be stored, so that these values may be tested against one another. There is no limit to the number of values that may be tested in a multivariate testing system such as this, except the limits imposed on the system that require enough requests to achieve statistical significance.

At step 704, a request of the document is received. For example, a browser may request a copy of the web page. As requests for the web page arrive, the web page is delivered to the requestor by web service logic in test management system 100. At step 705, a modified version of the document is generated to fulfill the response. Modified versions of the web page may be used to honor any number of these requests to facilitate the comparison of each change. For example, a first request may be honored with the original copy of the web page, while a second request may be honored with a modified copy of the web page. This modified copy may include one or more alternate values for one or more elements of the web page. Performance metrics are generated to measure the performance associated with each individual change, or groups of changes.

### Example Content Management System

FIG. 1 illustrates a logical block diagram of a computing device on which an embodiment may be implemented. Content management system 100A includes similar components to test management system 100. Specifically, the operation of document management logic 130 and user interface logic 150 are the same in content management 100A and test management system 100 in an embodiment.

Content management system 100A includes content management logic 140A. Content management logic is configured to store and make changes to content data 170A in database 160 in an embodiment. In an embodiment, any web page or other document may be altered, stored, and managed by content management system 100A using methods described herein. For example, a user viewing a web page in a browser and invoke user interface logic 150 to display controls for making changes to the web page being viewed. User interface logic may be integrated into the browser via a plugin in an embodiment. In another embodiment, the web page may be selected by passing the URL or other web page identifier to content management system 100A.

Once the document is selected, document management logic 130 determines whether or not the document is controlled by content management system 100A. For example, if the web page has a URL that is associated with content management system 100A, then a copy of the data associated with the web page may already be stored in database 160. If the document has not been stored in database 160, then document management logic 130 parses the document to prepare it for storage and control. As discussed above in connection with test management system, document management logic 130 identifies each element of the web page by reading the tags within the web page, as well as the CSS elements and their properties. Document management logic recognizes any element of a web page that conforms to the Document Object Model.

If the selected web page is not under the control of content management system 100A, the user may be presented with a user interface that allows the user to select a location and other metadata for the document when parsing is complete or after editing has been performed. For example, if a user selects a web page that the user does not control, the user may not be able to change that web page. Instead, the user makes a template for a new web page based on the selected web page, and that template is stored in content management system 100A. The user may then select a location that is under the user's control for a web page to be created. In addition, the user may alter the stored data associated with the template to make changes to the text, images, and other elements of the web page. This enables fast replication and efficient template creation.

In an embodiment, a user selects a web page or other document that is under the control of content management system 100A. Document management logic 130 determines that the selected web page has been stored as content data 170A. User interface logic generates a user interface such as those illustrated in FIGS. 2-7. Using tool interface 220, the user may select elements of the web page to be changed, such as elements 209-213. In response to receiving the user's submitted elements to be changed, along with replacement values and content, content management system 100A replaces the elements of the web page in database 160.

In an embodiment, a web page or other document may be used to create a template. Instead receiving a request for content management system 100A to change the selected document, a request to make a copy of the requested document is received, and the copy is stored as a template in database 160. In an embodiment, document management logic 130 includes template management logic for storing and organizing templates to be used for the creation of new documents. User interface logic generates a template management interface to allow users to select a stored template on which to base a new document or web page.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

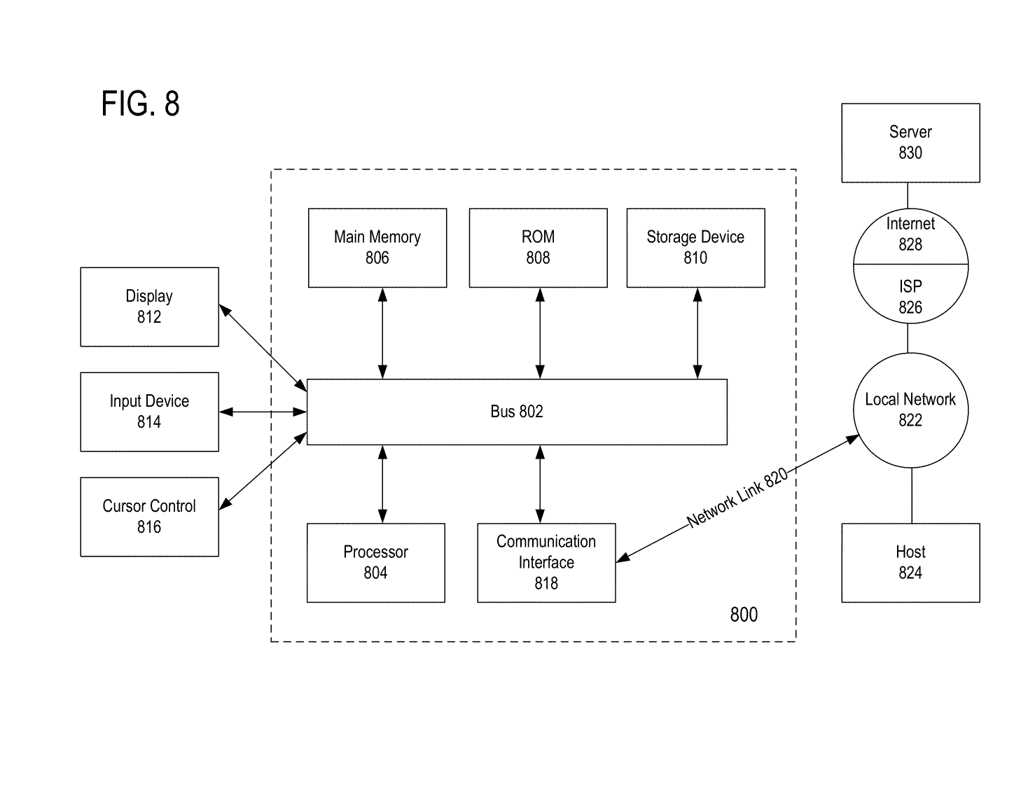

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a document, wherein the document includes a plurality of document elements;
parsing the document to identify one or more of the plurality of document elements included in the document, wherein a first document element of the identified document elements is associated with a first value;
receiving a request associated with the first document element, wherein the request is accompanied by a second value;
storing the second value;
in response to receiving a first request for the document, sending the document, wherein the value of the first document element is the first value;
in response to receiving a second request for the document, sending a first modified document, wherein the value of the first document element in the first modified document is the second value;
wherein the method is performed by one or more computing devices.

2. The method of claim 1, further comprising:
presenting a user interface that facilitates the selection of the one or more of the identified document elements.

3. The method of claim 2, wherein the user interface includes a display that renders a visual representation of the document and tools to manipulate identified document elements.

4. The method of claim 1, wherein one or more of the identified document elements are Document Object Model elements.

5. The method of claim 1, further comprising:
wherein a second document element of the identified document elements is associated with a third value;
receiving a request associated with the second document element, wherein the request is accompanied by a fourth value;
storing the fourth value;
in response to receiving a third request for the document, sending a second modified document, wherein the value of the second document element in the second modified document is the fourth value and the value of the first document element is the first value.

6. The method of claim 1, further comprising:
wherein a second document element of the identified document elements is associated with a third value;
receiving a request associated with the second document element, wherein the request is accompanied by a fourth value;
storing the fourth value;
in response to receiving the second request for the document, sending the first modified document, wherein the value of the second document element in the second modified document is the third value.

7. A computer-readable non-volatile storage medium storing instructions which, when executed by one or more processors, cause the one or more processors to perform:
receiving a document, wherein the document includes a plurality of document elements;
parsing the document to identify one or more of the plurality of document elements included in the document, wherein a first document element of the identified document elements is associated with a first value;
receiving a request associated with the first document element, wherein the request is accompanied by a second value;
storing the second value;
in response to receiving a first request for the document, sending the document, wherein the value of the first document element is the first value;
in response to receiving a second request for the document, sending a first modified document, wherein the value of the first document element in the first modified document is the second value.

8. The computer-readable non-volatile storage medium of claim 7, wherein the instructions further include instructions for:
presenting a user interface that facilitates the selection of the one or more of the identified document elements.

9. The computer-readable non-volatile storage medium of claim 8, wherein the user interface includes a display that renders a visual representation of the document and tools to manipulate identified document elements.

10. The computer-readable non-volatile storage medium of claim 7, wherein one or more of the identified document elements are Document Object Model elements.

11. The computer-readable non-volatile storage medium of claim 7, wherein the instructions further include instructions for:
wherein a second document element of the identified document elements is associated with a third value;
receiving a request associated with the second document element, wherein the request is accompanied by a fourth value;
storing the fourth value;
in response to receiving a third request for the document, sending a second modified document, wherein the value of the second document element in the second modified document is the fourth value and the value of the first document element is the first value.

12. The computer-readable non-volatile storage medium of claim 7, wherein the instructions further include instructions for:
wherein a second document element of the identified document elements is associated with a third value;
receiving a request associated with the second document element, wherein the request is accompanied by a fourth value;
storing the fourth value;
in response to receiving the second request for the document, sending the first modified document, wherein the value of the second document element in the second modified document is the third value.
